(19) United States
(12) Patent Application Publication
(10) Pub. No.: US 2024/0002141 A1
(43) Pub. Date: Jan. 4, 2024

(54) COMPOSTABLE BEVERAGE CONTAINER

(71) Applicant: SOCIETE DES PRODUITS NESTLE S.A., Vevey (CH)

(72) Inventors: CHRISTOPHE SEBASTIEN PAUL HEYDEL, Chez-Le-Bart (CH); PASCAL GIRARDIN, Grandvaux (CH)

(21) Appl. No.: 18/250,391

(22) PCT Filed: Oct. 1, 2021
(86) PCT No.: PCT/EP2021/077158

§ 371 Date: Apr. 25, 2023

(30) Foreign Application Priority Data
Oct. 27, 2020 (EP) 20204101.8

(51) Int. Cl. B65D 85/804; B65D 65/46; B65D 65/40

(52) U.S. Cl. CPC B65D 85/8046; B65D 65/466; B65D 65/40

(57) ABSTRACT

The invention relates to a beverage container (100) for preparing a beverage in a beverage production machine and a process for producing said compostable beverage container (100). The beverage container (100) is compostable and comprises a container wall (110) that encloses a volume (V) for containing a substance for the preparation of the beverage. The container wall (110) is made of a wall material that comprises at least two different laminate structures. The wall material comprises a first laminate structure (300) configured to be formable. The first laminate structure (300) defines the volume (V) and comprises at least one cutout opening (311, 312). The wall material also comprises a second laminate structure (400), which is configured to be openable upon interaction with opening elements of the beverage production machine under the effect of rising pressure of a fluid being injected into the beverage container (100). Therein, the second laminate structure (400) covers completely the at least one cutout opening (311, 312) so that the first laminate structure (300) and the second laminate structure (400) as the container wall (110) completely enclose the volume (V).

### 1. FIELD OF THE INVENTION

The present invention relates to a compostable beverage container for preparing a beverage in a beverage production machine comprising a container wall that encloses a volume for containing a substance for beverage preparation and that opens upon interaction with opening elements of the beverage production machine under the effect of rising pressure of a fluid being injected into the beverage container. Further, the present invention relates to a process for producing the compostable beverage container.

### 2. TECHNICAL BACKGROUND

Single-serve beverage containers, such as capsules or pods, for beverage preparation machines are known in the art. These beverage containers are commonly used for on demand dispensing of beverages, like coffee, tea or hot chocolate, and enjoy popularity due to fresh tasting, variability of flavours and convenience of the beverage preparation.

Usually, the beverage container containing a beverage component is inserted in a container holder of a beverage preparation machine, the container holder is closed and preparation of the beverage is started. Fluid, such as water or milk, is delivered to the beverage container to interact with the beverage component contained inside the beverage container to produce the desired beverage. When a sufficient amount of the fluid fills the beverage container, the beverage container opens under pressure of the fluid to release the prepared beverage. For example, opening of the beverage container can be accomplished by pressing an extraction face of the beverage container with a force effected by increasing pressure of the fluid inside the beverage container against an opening structure provided in the container holder such that the extraction face is torn upon reaching a breaking stress. The opening structure can be a number of relief and recessed elements, e.g. pyramid-like elements, onto which the extraction face extends and tears under the effect of the internal pressure of the fluid. Such pressure controlled beverage preparation has the advantage that it can produce a beverage of high quality.

In the prior art, such beverage containers are usually made of plastic and/or aluminium. These materials offer advantages, such as high pressure resistance, durability, flexibility, low weight, provision of long shelf-life and letting the taste of the prepared beverage unaltered. Unfortunately, reusing and recycling such materials is challenging.

Therefore, attempts were made to replace these materials with alternative materials that overcome the problems of disposing and/or recycling used beverage containers. For example, paper and bioplastics, e.g. made from cornstarch or sugarcane fibre, are proposed as alternative beverage container materials. Making a beverage container from these materials could overcome the problems relating to the disposal and/or recycling of single use beverage containers.

In particular, paper-based materials offer the advantage that the beverage container is relatively stiff while being formable into the shape of existing beverage containers. Thereby, compatibility with available beverage preparation machines can be achieved. However, paper-based materials do not inherently possess a reliable oxygen and moisture barrier. Moreover, paper-based materials seem to be unsuitable for forming an extraction face for engaging with an opening structure of a beverage preparation machine. For example, a paper-based material may absorb some of the fluid leaving the beverage container during the beverage preparation process, thereby causing disintegration of the beverage container material into paper fibres. The disintegration process may be aggravated due to the temperature and pressure conditions that exist during the beverage preparation process. The fibres may remain and accumulate between the relief and recessed elements of the opening structure, thus requiring a cleaning step before a new beverage preparation process can be started to avoid blockages. However, available beverage production machines do not provide such cleaning functionality. In addition, in a moistened state the paper-based container may adhere with its extraction face to the opening structure. This may lead to the entire beverage container being stuck inside the beverage preparation machine. Also, printing on paper-based materials is challenging, as there is a risk that the ink may come into contact with the beverage component or the beverage to be prepared, thereby conflicting with food safety regulations. In comparison, bioplastics offer the advantage of providing a moisture and/or gas barrier while being water resistant and stretchable materials. However, these materials lack the rigidity required in the beverage preparation process and soften at relatively low temperatures (e.g. 70 degree Celsius), thereby rendering these materials unsuitable for forming a beverage container. Approaches that see bioplastics combined with paper-based materials, e.g. by laminating, failed as at least disadvantages of one of the materials persisted.

Thus, there is a need to provide an alternative material or structure for beverage containers, which remain usable for existing beverage preparation machines. Such beverage containers must be not only compostable but also suitable for preparing beverages with the quality, the reproducibility of flavours and consistency of the known aluminium based beverage containers.

Therefore, it is an object of the present invention to provide a beverage container, which is compatible with existing beverage preparation machines and which has a configuration and design that facilitates the use of compostable materials while maintaining and/or exceeding the quality and continuity standards of beverages prepared with a comparable aluminium beverage container. It is further an object of the present invention to provide a process for producing such beverage container.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a beverage container for preparing a beverage in a beverage production machine. The beverage container is compostable.

Therein, the beverage container may be a pod, a capsule or a pouch. Further, the term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth may be supplied with nutrients once the material has completely broken down. International standards, such as EU 13432 or US ASTM D6400, provide a legal framework for specifying technical requirements and procedures for determining compostability of a material. For example, one of the tests for compostability requires that—in order to be considered “industrially compostable”—at least 90% of the material in question is to be biologically degraded under controlled conditions within 6 months. Similar tests exist for home composting certification. Furthermore, according to the mentioned standards, compostable plastic materials must have the following characteristics simultaneously to be considered compostable: the material must be biodegradable and disintegrable, i.e. fragmentation and invisibility in the final compost, and it must not have negative effects on the composting process and quality.

The beverage container comprises a container wall that encloses a volume for containing a substance for the preparation of the beverage.

Therein, the term “enclose” may be understood, for example, as (sealingly) surrounding, covering, wrapping and/or encasing a space, a mass, such as the substance, or an object. The term “substance” may be understood, for example, as any type of (solid, liquid, at least partially soluble and/or percolate-able) matter of a particular or definite chemical constitution. Examples for substances may be roasted ground coffee, instant coffee, tealeaves, syrup concentrate, fruit extract concentrate, a chocolate product, dehydrated edible substances, and/or combinations thereof.

The container wall is made of a wall material that comprises at least two different laminate structures.

Therein, the expression “laminate structure” may be understood, for example, as a structure comprising different parts that are arranged in plies, slats, tiers or as strata. The term “different” may be understood, for example, as two elements being at least partially dissimilar, preferably so that said two elements are unlike each other, e.g. in consistence, composition, structure, order of layers and/or number of layers.

The container wall comprises a first laminate structure, which is configured to be formable.

Therein, the term “formable” may be understood, for example, as the characteristic of a material being malleable, pliable, and/or shapable, preferably with or without the support of additional tools and/or preferably with or without the application of heat and/or water. For example, in a dry pulp moulding process, a blank of dried cellulose fibres may be provided and formed into a (permanent) shape of the beverage container with a tool under the application of heat and water.

Further, the first laminate structure defines the volume and comprises at least one cutout opening.

Therein, the expression “defining a volume” may be understood, for example, as marking/setting limits/contours of a preferably enclosed space. The expression “cutout opening” may be understood, for example, as an opening that may be formed by cutting matter out of a material. For example, the cutout opening may be specified by a sharp edge defining the cutout opening and/or by a perforation in the material. For example, the cutout opening may be a through hole, preferably forming a passage between two opposite (and otherwise (by the material) separated) sides of the material, in which the cutout opening may be provided.

The container wall comprises a second laminate structure, which is configured to be openable upon interaction with opening elements of the beverage production machine under the effect of rising pressure of a fluid being injected into the beverage container.

The term “openable” may be understood, for example, as capability of being provided with holes, punctures and/or ruptures. Preferably, the provision of such openings may be subject to certain conditions and/or circumstances, such as the provision of the opening elements and/or excess of a certain pressure inside the beverage container.

The second laminate structure completely covers the at least one cutout opening so that the first laminate structure and the second laminate structure as the container wall completely enclose the volume.

Thereby, it is possible to provide a beverage container from compostable materials. The beverage container is not only compatible with existing beverage production machines but also meets the high standards set by capsules made of plastic and/or aluminium.

As described above, this can be achieved by providing the beverage container with a container wall, which (completely) surrounds the beverage container's volume for receiving a substance for the preparation of the beverage. Therein, the container wall's wall material comprises at least two distinguishable laminate structures, namely at least a first laminate structure and a second laminate structure. The first laminate structure is formable. Thereby, the container wall can be formed into a shape that is compatible with existing capsule machines. The first laminate structure comprises a cutout opening that is completely covered by the second laminate structure, which is different from the first laminate structure. Thereby, the technical challenge of providing the beverage container with different material properties can be overcome and thus, material properties required on an extraction face of the beverage container can be supplied besides other material characteristics that may be required. This allows providing the wall material of the beverage container such that different sections of the beverage container are made of different components of the wall material. Thus, the container wall can supply/show different material properties depending on the functional requirements of a part/portion of the beverage container. The wall material comprising different laminate structures allows that each of these laminate structures can be tailored individually to the technical requirements of the respective portion of the container wall. Additionally, structural integrity between the different laminate structures of the wall material can be ensured as each of the laminate structures can be designed to form a strong connection/bond between the laminate structures.

Thus, the existing problems of the prior art can be overcome with the present invention.

According to a preferred embodiment, the first laminate structure may comprise at least a formable paper material layer and a compostable film material layer as an oxygen barrier. Preferably, the compostable film material layer may be laminated or coextruded with the formable paper material layer. Preferably, the compostable film material layer may comprise a compostable bioplastic. The formable paper material layer may have a grammage between 80 g/m² to 150 g/m². For example, the formable paper material layer may be a Kraft paper.

By the mixed presence of paper material and compostable film material, the beverage container can be provided with compostability, formability, sealability as well as an oxygen and/or moisture barrier. Moreover, the beverage container may be provided with a temperature resistance sufficient for hot extraction processes. For example, the formable paper material layer may be formable by being stretched (to be deformed permanently) in traverse and longitudinal directions. At the same time, the formable paper material layer may provide the beverage container with rigidity sufficient for building up pressure inside the beverage container. In addition, the compostable film material layer may also facilitate the gliding of the beverage container during insertion in and ejection from the beverage production machine. The compostable film material layer may preserve the paper material from humidity during storage and provide a surface suitable for being printed on.

According to a further preferred embodiment, the compostable film material layer may comprise a layered structure. Preferably, the compostable film material layer may comprise a layered structure (entirely/exclusively) made of compostable materials.

By supplying the compostable film material as a “layered structure”, which may be understood, for example, as any structure that may be formed or arranged in layers, the compostable film material layer can be adapted to the requirements of the application.

The compostable film material layer may comprise a moisture barrier layer. Preferably, the moisture barrier layer may extend with a thickness in the range between 10 micrometres to 40 micrometres. The moisture barrier layer may be made of starch, Polylactic acid (PLA), Polyhydroxyalkanoate (PHA), Polybutylenesuccinate (PBS), and/or Polybutylene Adipate Terephthalate (PBAT). Alternatively or additionally, the compostable film material layer may comprise a gas barrier layer. Preferably, the gas barrier layer may extend with a thickness in the range between 1 micrometres to 20 micrometres. The gas barrier layer may be made of Polyvinyl Alcohol (PVOH) or Butenediol Vinyl Alcohol Co-polymer (BVOH).

Thereby, it is possible to provide the first laminate structure as a formable structure having a moisture and/or oxygen barrier. By specifying the thickness of the moisture barrier layer and/or of the gas barrier layer, the reliability and the effectiveness of the barrier as well as its durability can be ensured.

Alternatively or additionally, the compostable film material layer may comprise an adhesive layer. Preferably, the adhesive layer may extend with a thickness in the range between 1 micrometres to 10 micrometres. The adhesive layer may be made of an adhesive, such as vegetable-based starch or acrylic adhesive.

Thereby, it is possible to connect individual layers of the compostable film material layer to each other. This may be particularly advantageous for connecting layers that cannot be laminated or sealed to each other without additional binding means.

Preferably, the compostable film material layer may comprise a (sandwich) structure with the gas barrier layer being sandwiched between two moisture barrier layers, thereby forming the top and the bottom of the compostable film material layer. Therein, two adhesive layers may be provided between each of the moisture barrier layers and the gas barrier layers, respectively.

Thereby, the container wall can be provided such that it (or at least the sections of the container wall comprising the first laminate structure) blocks moisture and oxygen.

Also, the configuration of the first laminate structure prevents the formable paper material layer and the gas barrier layer from absorbing moisture during the beverage preparation so that the functionality of the first laminate structure can be maintained.

According to a preferred embodiment, the second laminate structure may comprise a paper material layer. The paper material layer may be a Kraft paper. The paper material layer may have a grammage between 20 g/m² and 100 g/m². The second laminate structure may further comprise an interface layer. Preferably, the interface layer may extend with a thickness in the range of 10 micrometres to 30 micrometres. The interface layer preferably may be made of cellophane or Polylactic acid (PLA). Alternatively or additionally, the interface layer may preferably be made of the same material as the compostable film material layer or of a polymer family member of the above described compostable film material layer.

Thereby, it is possible to provide (also) the second laminate structure as a mixture of a paper-based material with a material providing protection against tearing, oxygen and/or humidity. Therein, the paper material layer and the interface layer may be provided such that the second laminate structure is flexible and stretchable to expand under pressure while being sufficiently soft to facilitate perforation of the second laminate structure with the opening elements. The configuration of the interface layer may help to keep the orifices perforated in the paper material layer open. It may also keep the orifices at a constant size and in the same position and may effect that the paper material layer does not tear through in an uncontrolled manner. In addition, the interface layer improves gliding of the beverage container when passing through the beverage production machine. The interface layer may preserve the paper material layer from humidity during storage and may form a suitable surface for printing.

According to a preferred embodiment, the second laminate structure may further comprise an add-on layer. The add-on layer may preferably be made of preferably coated cellophane or Polylactic acid (PLA). Alternatively or additionally, the second laminate structure may further comprise a filter layer. The filter layer may preferably be made of a non-woven material. Preferably, the add-on layer and/or the filter layer may be provided opposite to the interface layer with respect to the paper material layer.

By providing additional layers, it is possible to include additional functional layers into the second laminate structure. Therein, the use of non-woven materials may be advantageous. Commonly, “non-woven materials” may be made from short and long fibres being bonded together by mechanical, chemical, thermal treatment. Non-woven materials may be advantageous as they can be engineered for a specific use and can be recycled after being used. Also, non-woven materials may provide material functionalities, such as resilience and tear resistance, tensile strength, low weight, filtration, and/or providing sterility and a bacterial barrier. Examples may be wood pulp, sugarcane pulp, cellulose fibres, rayon fibres, polybutylene succinate (PBS), poly(butylene succinate-co-butylene adipate) (PBS-A/PBSa), polyhydroxybutyrate (PHB) and/or Polylactic acid (PLA). Thereby, it is possible to provide the beverage container with a layer that is particularly suitable for retaining components of the substance inside the beverage container that are not intended for consumption, such as tealeaves, coffee infusions or fibrous components. Moreover, by providing additional layers, such as the add-on layer, components or layers of the wall material can be arranged differently, thereby providing more freedom to design the beverage container.

According to a preferred embodiment, the first laminate structure may be configured such that it may have an elongation at its breaking point of at least 2%, preferably between 2% and 20%.

Thereby, it is possible to provide the beverage container with a container wall that may retain its structural integrity despite being exposed to relatively high mechanical stresses. Thereby, it can be achieved that the beverage container can be used for the preparation of beverages, like coffee, which may require high pressures.

According to a further preferred embodiment, the second laminate structure may have a puncture resistance between 3 N/15 mm and 10 N/15 mm for an elongation between 1.5 mm and 3 mm. Preferably, therein the rate (velocity) of penetration may be 300 mm/min and/or more preferred, the diameter of the probe head may be 15 mm.

Therein, the expression “puncture resistance” may be understood as a resistance of a material or structure to being penetrated/punctured from a contact with a solid object. In a puncture test, for example, the energy required to force a puncture head of a defined size and shape completely through a specimen may be measured. For example, in the test method specified in normative ASTM F1306-90(2008) a biaxial stress is applied at a single test velocity on the material until perforation (e.g. the development of a measurable flaw through a film undergoing penetration) occurs. The test is conducted at room temperature (e.g. 23 degree Celsius, 50% r.h.). The force, energy and/or elongation to perforation can be used to describe the puncture resistance.

Thereby, it is possible to provide the beverage container with a container wall that will open at a defined pressure inside the beverage container. The respective resistance range ensures that the second laminate structure is suitable for a beverage preparation, which requires the existence of high pressures. In addition, safe storage of the product contained inside the beverage container can be ensured.

According to a preferred embodiment, the second laminate structure may be connected (sealed, laminated and/or glued) to the first laminate structure to completely cover the at least one cutout opening. Alternatively or additionally, a circumferential first rim section of the first laminate structure surrounding the cutout opening may be connected to a circumferential second rim section of the second laminate structure.

Thereby, it can be ensured that the first laminate structure and the second laminate structure are reliably connected to each other so that the volume can be completely sealed from the outside of the beverage container.

Preferably, the first laminate structure (and/or the first rim section) and the second laminate structure (and/or the second laminate structure) may be connected by connecting the interface layer and the compostable film material layer to each other.

Thereby, it is possible to form a connection between the two laminate structures without having to provide an additional adhesive. Moreover, the connection between the two respective layers may be achieved by heat sealing so that the manufacturing process can be simplified. Also, said two layers may also provide a barrier against gas or moisture, which can be maintained also in the connecting parts of the two layers.

Alternatively or additionally, the second laminate structure may be provided on an opposite or same side as the volume with respect to the first laminate structure.

Thereby, it is possible to provide different configurations of the beverage container, each of which may have different properties. For example, the beverage container may be more prone to resist higher pressures if the second laminate structure is provided on the same side as the volume as the first laminate structure may provide additional support by forming a rigid frame structure, by which the second laminate structure can be supported. In comparison, the beverage container may be more aesthetically appealing, easier (and with a larger surface) to be printed on, and/or may glide easier into and out of the beverage production machine if the second laminate structure is provided on an opposite side of the volume as the second laminate structure may cover a—in comparison to the other arrangement—larger surface area of the beverage container.

Alternatively or additionally, the wall material, the first laminate structure and/or the second laminate structure may be provided as a preferably continuous foil, film, sheet or membrane.

Thereby, it is possible to laminate or seal the respective laminate structures to each other so that not only a reliable bond can be established between the respective structures but also manufacturing the same can be reduced in costs and complexity.

According to a further preferred embodiment, the first laminate structure may consist of at least two separate elements that may be circumferentially sealed to each other at a flange to enclose the volume. Therein, each of the elements may comprise a circumferential edge section, which may be arranged to overlap to form the flange.

Thereby, it is possible to simplify the design and manufacturing processes of the beverage container. In addition, a reliable bond between the two separate first laminate structure elements can be established as the same materials are sealed to each other.

According to a preferred embodiment, the first laminate structure may comprise one or more further cutout openings. The one or more further cutout openings may preferably be completely covered by the second laminate structure, for example to be opened by injection elements of the beverage production machine for injecting the fluid into the beverage container. Preferably, the further cutout opening may be provided with respect to the volume opposite to the cutout opening, for example for engaging with the opening elements. Alternatively or additionally, the second laminate structure may preferably consist of a plurality of separate elements with at least one for each of the cutout openings. Moreover, the at least one cutout opening may be configured such that elements of the beverage production machine, such as the opening elements and/or injection elements, during the beverage preparation in the beverage production machine preferably exclusively engage with the second laminate structure.

Thereby, the beverage container can be provided with at least two sections that are suitable for interacting with components of the beverage production machine. For example, the injection or opening elements of the beverage production machine can be easily inserted and removed from the container wall. Thus, it can be avoided that the beverage container adheres to a surface of the container holder. This facilitates that the beverage production machine can be used repeatedly, reliably and without the necessity of additional cleaning steps with the compostable beverage container.

According to a preferred embodiment, the container wall (preferably the second laminate structure and/or the first laminate structure) may comprise an identifier. The identifier may preferably be printed on a surface of the beverage container (or the second laminate structure) directed away from the volume. The identifier may, for example, comprise information relating to the type of the substance contained in the volume and/or to beverage preparation parameters, such as defined pressure or temperature ranges required in the beverage preparation.

Thereby, it is possible to provide additional information on the beverage container in a food safe manner as the ink is prevented from coming into contact with the substance or the beverage. The information can be used by a consumer to identify the content of the beverage container. The identifier may be used by the beverage production machine to identify the desired beverage. Based on the provided information, the beverage production machine may automatically prepare the desired beverage according to a recipe stored in a control unit of the beverage production machine.

A further aspect of the present invention relates to a process for producing the above described compostable beverage container for preparing a beverage in a beverage production machine. In the process, a first laminate structure, which is configured to be formable, and a second laminate structure, which is configured to be openable upon interaction with opening elements of the beverage production machine under the effect of rising pressure of a fluid being injected into the beverage container, are provided. At least one cutout opening is cut into the first laminate structure.

Therein, the expression “cutting” may be understood, for example, as removing or weakening material by at least partially penetrating the same with an edged instrument.

At least the first laminate structure is formed such that a volume of the beverage container for containing a substance for the preparation of the beverage is defined. The first laminate structure and the second laminate structure are connected to each other such that the second laminate structure completely covers the at least one cutout opening to completely enclose the volume of the beverage container with the first laminate structure and the second laminate structure as a container wall.

According to a preferred embodiment, the volume may be formed in the forming step by circumferentially sealing at least two separate elements of the first laminate structure to each other along a circumferential edge section of the respective elements. Further, the first laminate structure and the second laminate structure may be connected to each other by gluing, heat sealing and/or by partial lamination. It is conceivable that in the process, the connecting step may be completed before, after or at the same time as the step of cutting the cutout opening. Alternatively or additionally, the connecting step may be completed before, after or at the same time as the forming step. Alternatively or additionally, the forming step may be completed before, after or at the same time as the cutting step. The step of providing the first laminate structure may comprise the step of cutting the first laminate structure and/or the second laminate structure to size. This (additional) step may be carried out simultaneously with the step of cutting the at least one cutout opening.

Thereby, it is possible to produce a beverage container with the advantages described above. In particular, it is possible to produce a beverage container from compostable materials in a cost effective and simplified manner that facilitates to form the beverage container at the site of filling and that can be applied to any beverage container without the need of providing special manufacturing machinery. Thus, problems existing in manufacturing methods of the prior art can be overcome by the present invention.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings.

In case numerals have been omitted from a figure, for example for reasons of clarity, the corresponding features may still be present in the figure.

FIG. 1 shows a schematic cross-section of a first embodiment of a beverage container of the present invention.

FIG. 2 shows a schematic top view of the beverage container of FIG. 1.

FIG. 3 shows an enlarged schematic cross-section of a section of the beverage container's container wall from FIG. 1.

FIGS. 4A to 4C schematically show steps of a first embodiment of the process of the invention for producing the beverage container of the invention.

FIGS. 5A to 5D schematically show steps of a second embodiment of the process of the invention for producing the beverage container of the invention.

FIGS. 6A to 6D schematically show steps of a third embodiment of the process of the invention for producing the beverage container of the invention.

FIG. 7 shows a schematic cross-section of a second embodiment of the beverage container of the present invention.

FIG. 8 shows an enlarged schematic cross-section of a section of the beverage container's container wall from FIG. 7.

### 5. DETAILED DESCRIPTION

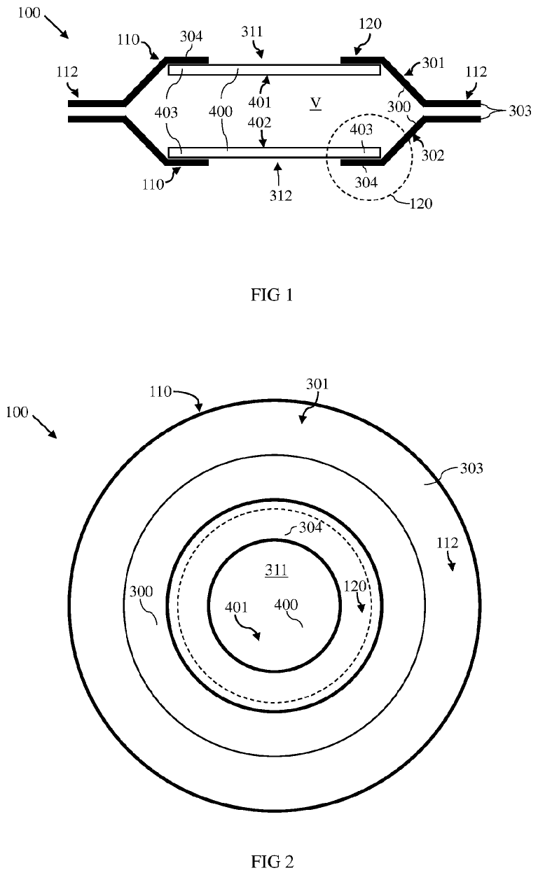

The figures show different views and aspects of the present invention. In particular, FIGS. 1 to 3, 7 and 8 show different aspects and embodiments of a beverage container 100 for preparing a beverage in a beverage production machine according to the present invention. FIGS. 4 to 6 show different embodiments of a process for producing the beverage container 100 according to the present invention.

For example, the beverage container wo may be a pod as exemplarily shown in FIGS. 1, 2 and 7. Alternatively, the beverage container 100 may be a capsule or a pouch. The beverage container 100 may be configured to be used in a beverage production machine, which may preferably comprise elements for opening the beverage container 100 under the effect of rising pressure of a fluid that is injected inside the beverage container 100.

The beverage container 100 is compostable. Thus, the beverage container 100 may be simply disposed after its use without much consideration in industrial or home compost piles. Thus, the entire contents of the beverage container 100, including any beverage components contained therein, may be not only biodegradable but also compostable.

The beverage container 100 comprises a container wall 110 that encloses a volume V for containing a substance for the preparation of the beverage as exemplarily illustrated in FIGS. 1, 3, 7 and 8.

Therein, the volume V may have any shape, form or size. Preferably, the container wall 110 may enclose a space inside the beverage container 100 as the volume V. The capacity of the volume V may be such that at least an amount of the substance required for the beverage preparation may be received therein. For example, if a food product, such as coffee powder, is used as the substance, the volume V may have at least a capacity sufficient to receive a dosage of coffee between 4 to 12 grams. In general, the substance may be an (extractable) food substance, such as ground coffee powder, tea or chocolate. Preferably, the substance may be a roast-and-ground and/or may be compacted to form a tablet or cake.

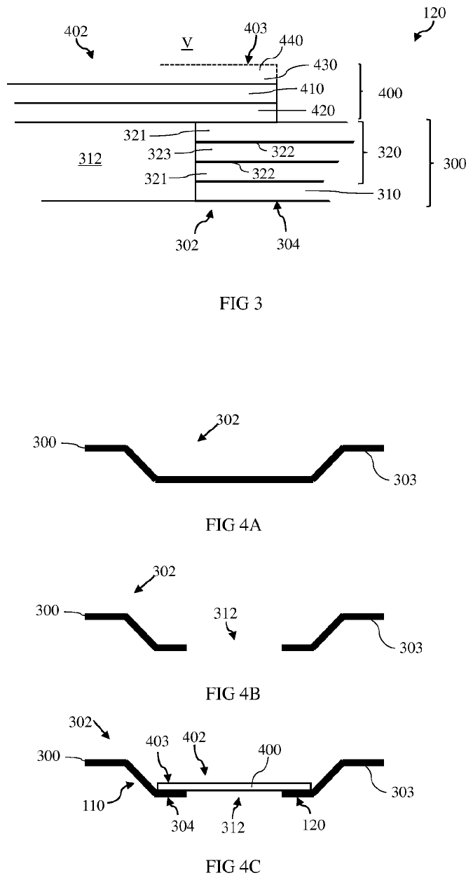

The container wall 110 is made of a wall material. The wall material may be provided as a continuous foil, film, sheet or membrane as can be taken particularly well from the exemplary illustrations of FIGS. 3 to 6. The wall material is compostable in its entirety.

The wall material comprises at least two different laminate structures. The provision of two different laminate structures is shown in all Figures but highlighted in the examples shown in the FIGS. 1 and 4 to 7 by representing one of the two laminate structures as filled graphical element while the other one of the two laminate structures is shown as blank graphical element.

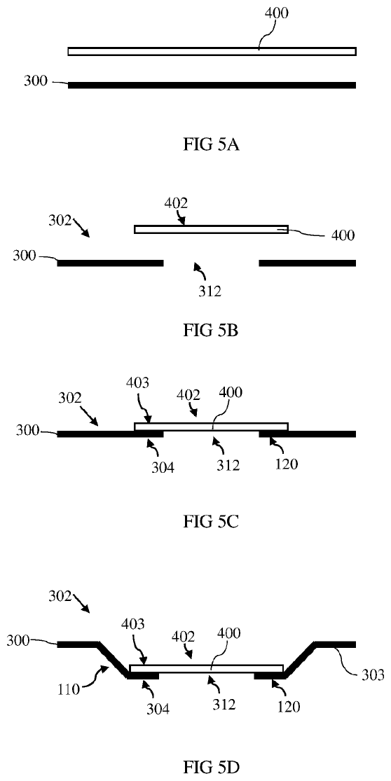

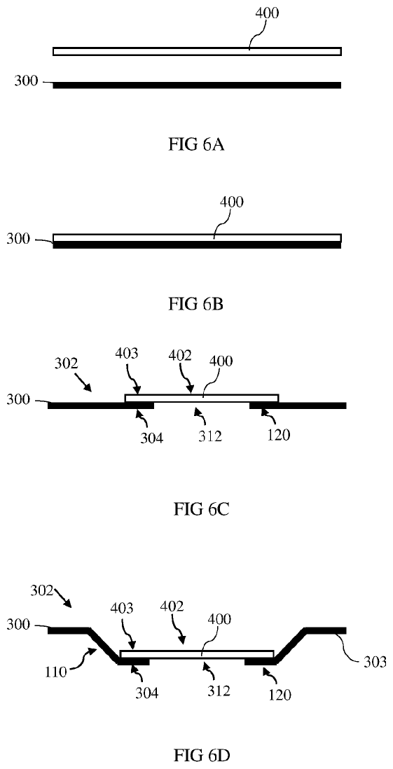

The wall material comprises a first laminate structure 300 that is configured to be formable. FIGS. 5 and 6, for example, illustrate the formability (malleability) of the first laminate structure 300 by showing that the first laminate structure 300, which may be provided as a continuous foil, film, membrane or sheet, may be formed from a blank sheet (permanently) into the later shape of the beverage container 100. To provide the wall material with such formability, the first laminate structure 300 may be configured such that it has an elongation at its breaking point of at least 2%, preferably between 2% and 20%. Therein, the first laminate structure 300 may be a laminate, which may comprise an arbitrary number of layers as exemplarily illustrated in FIGS. 3 and 8.

For example, the first laminate structure 300 may comprise a formable paper material layer 310. The formable paper material layer may have a grammage between 80 g/m² to 150 g/m². For example, the formable paper material layer may be a Kraft paper. Preferably, the formable paper material layer may be exclusively made of cellulose fibres. More preferred, the formable paper material layer may contain fibres (with a composition of long fibres that is higher than short fibres) and preferably may comprise additives, such as starch, carboxymethylcellulose (CMC), latex or biodegradable resins.

In addition, the first laminate structure 300 may comprise a compostable film material layer 320. Preferably, the compostable film material layer 320 may comprise or be made of a compostable bioplastic. The compostable film layer 320 may act as a moisture and/or an oxygen barrier. Therefore, the compostable film material layer 320 may comprise a layered structure to provide the beverage container 100 with an oxygen and/or a moisture barrier. This is exemplarily illustrated in FIGS. 3 and 8. Therein, the compostable film material layer 320 may comprise at least one moisture barrier layer 321, which may be made of starch, PLA, PHA, PBS and/or PBAT. For example, in FIGS. 3 and 8, the compostable film material layer 320 is illustrated with two moisture barrier layers 321. Each of the two moisture barrier layers 321 may extend with a thickness in the range between 10 micrometres to 40 micrometres. Alternatively or additionally, the compostable film material layer 320 may comprise at least one gas barrier layer 323, which may be made of cellophane, Ethylene vinyl alcohol (EVOH), PVOH, BVOH and/or SiOx. Preferably, the gas barrier layer 323 may extend with a thickness in the range between 1 micrometres to 20 micrometres. In FIGS. 3 and 8, the compostable film material layer 320 is exemplarily illustrated as comprising a single gas barrier layer 323. Thus, for example, the compostable film material layer 320 may comprise a combination of the materials PLA-PVOH-PLA. However, this is only an example and multiple gas barrier layers 323 may be provided. Also, an adhesive layer 322 may be provided. The adhesive layer 322 may be made of an adhesive, such as vegetable-based starch or acrylic adhesive and may preferably extend with a thickness in the range between 1 micrometres to 10 micrometres. For example, the adhesive layer 322 may be provided such that the gas barrier layer 323 is connected with the moisture barrier layer 321 via the adhesive layer 322. FIGS. 3 and 8 exemplarily illustrate a structure of the compostable film material layer 320, where the top and the bottom of the compostable film material layer 320 may be formed by two moisture barrier layers 321. The barrier layer 323 in these Figures is illustrated as being sandwiched between and connected to the two moisture barrier layers 321 via two adhesive layers 322. However, this is only an example and there is no limitation on the number of layers the compostable film material layer 320 may have.

The compostable film material layer 320 may be laminated or coextruded with the formable paper material layer 310. FIGS. 3 and 8 show exemplarily such a layered structure of the first laminate structure 300. Preferably, the compostable film material layer 320 may be provided on the formable paper material layer 310 such that during a forming process of the first laminate structure 300 the compostable film material layer 320 may be stretchable and formable as the formable paper material layer 310.

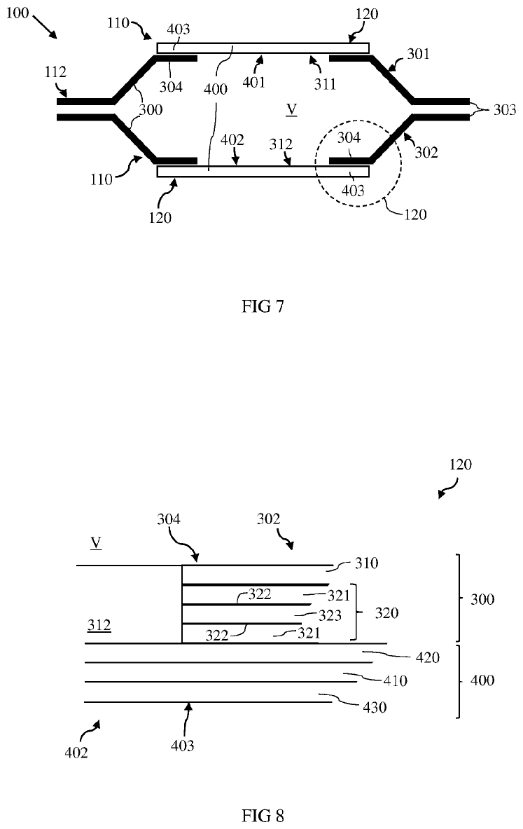

The first laminate structure 300 defines the volume V as shown in FIGS. 1 and 7, for instance. Preferably, the first laminate structure 300 may consist of at least two separate elements 301, 302 that may be sealed (circumferentially) to each other to enclose the volume V. Each of the elements 301, 302 may comprise a circumferential edge section 303. The respective circumferential edge sections 303 may be arranged to overlap and to be sealed to each other, thereby forming a flange 112 of the beverage container 100. FIGS. 1, 2 and 7 show this exemplarily. Preferably, the two elements 301, 302 may be provided such that the formable paper material layer 310 is directed to a side opposite to the volume V as exemplarily illustrated in FIGS. 1 to 3. Thus, sealing of the two elements 301, 302 may be accomplished via two abutting compostable film material layers 320 and no additional sealing aids may be required. In comparison, the two elements 301, 302 may be provided such that the formable paper material layer 310 is directed to the same side as the volume V as exemplarily illustrated in FIGS. 7 and 8. Thus, additional sealing aids, like an adhesive, may be required to form a connection between the abutting formable paper material layers 310 of the two elements 301, 302.

The first laminate structure 300 comprises at least one cutout opening 311. This is exemplarily shown in all Figures. Preferably, the first laminate structure 300 may comprise one or more further cutout opening 312 as FIGS. 1 and 7 exemplarily show. Generally, there is no limitation in the number of cutout openings 311, 312 the first laminate structure 300 may have. Preferably, each of the elements 301, 302 may comprise at least one cutout opening 311. For example, one of the elements 301, 302 may comprise the cutout opening 311 while the respective other element 301, 302 comprises the further cutout opening 312. Thereby, it may be possible to provide the further cutout opening 312 with respect to the volume V opposite to the cutout opening 311 as illustrated in FIGS. 1 and 7. Preferably, each of the cutout openings 311, 312 may be configured and/or provided/arranged such that elements of the beverage production machine, such as the opening elements and the injection elements, do not engage and/or come into contact with the first laminate structure 300 in the beverage production machine during the beverage preparation. This may be achieved by dimensioning and/or positioning the cutout openings 311, 312 accordingly.

Furthermore, the wall material comprises a second laminate structure 400 as exemplarily shown in all Figures. The second laminate structure 400 may be provided as a continuous foil, film, sheet or membrane. The second laminate structure 400 is configured to be openable upon interaction with opening elements of the beverage production machine under the effect of rising pressure of a fluid being injected into the beverage container 100. For this, the second laminate structure 400 may have a puncture resistance between 3 N/15 mm and 10 N/15 mm for an elongation between 1.5 mm and 3 mm.

Preferably, the second laminate structure 400 may comprise a layered and/or laminated structure as illustrated in FIGS. 3 and 8. For example, the second laminate structure may have a paper material layer 410. The paper material layer 410 may preferably have a grammage between 20 g/m² and 100 g/m². The paper material layer 410 may be a preferably yieldable paper, such as a Kraft paper. The paper material layer 410 may comprise an aerated structure to provide softness to facilitate its perforation. In addition, the second laminate structure 400 may comprise an interface layer 420. The interface layer 420 may be made of cellophane or PLA. Alternatively or additionally, the interface layer 420 may be made of the same material as at least one of materials used for the compostable film material layer 320 or a polymer family member thereof. The interface layer 420 may extend with a thickness in the range of 10 micrometres to 30 micrometres. The interface layer 420 may or may not provide a moisture and/or gas barrier. In particular, it is also conceivable that the interface layer 420 is provided with such a barrier in a surface treatment process.

The second laminate structure 400 may further comprise an add-on layer 430 and/or a filter layer 440. Each of these layers are indicated as being optional by using broken lines in FIG. 3. For example, the add-on layer 430 may be an additional layer for providing a moisture and/or oxygen barrier and may be made of preferably coated cellophane, PLA or parchment paper. The filter layer 440 may be provided for filtering particles and residues of the substance from the prepared beverage. By providing the filter layer 440, tea may be advantageously prepared with the beverage container 100, for instance. It is conceivable that the filter layer 440 may be made of a non-woven material, for example. Preferably, the add-on layer 430 and/or the filter layer 440 may provided opposite to the interface layer 420 with respect to the paper material layer 410. This is exemplarily shown in FIGS. 3 and 8. However, it may be necessary to provide the add-on layer 430 as a moisture and/or oxygen barrier in the configuration exemplarily illustrated in FIG. 8 as otherwise the paper material layer 410 would solemnly form the outer side of the beverage container 100.

The second laminate structure 400 completely covers the at least one cutout opening 311, 312 so that the first laminate structure 300 and the second laminate structure 400 as the container wall 110 completely enclose the volume V. This is exemplarily illustrated in all Figures. Therein, also the further cutout opening 312 may be completely covered by the second laminate structure 400, thereby facilitating the beverage container 100 to be opened by injection elements of the beverage production machine for injecting the fluid into the beverage container 100. For this, the second laminate structure 400 may provided such that it consists of a plurality of separate elements 401, 402 so that at least one separate element 401, 402 exists for each of the cutout openings 311, 312. However, it is also conceivable that only one element of the second laminate structure 400 exists that may cover each of the cutout openings 311, 312. The first laminate structure 300 may be connected to the second laminate structure 400, for example by gluing, (heat-) sealing or laminating. As exemplarily shown in detail in FIGS. 1, 3, 7 and 8, the first laminate structure 300 may comprise a circumferential first rim section 304, which surrounds the cutout opening 311. The first rim section 304 may be connected to a circumferential second rim section 403 of the second laminate structure 400 to completely cover the cutout opening 311. Thereby, an overlapping section 120 of the beverage container 100 is formed, which preferably extends with the portions of the first rim section 304 and of the second rim section 403 that cover and/or overlap with each other. Therein, the cutout opening 311, 312 may be covered by the second laminate structure 400 such that the volume is completely sealed from the outside. Preferably, the second laminate structure 400 may cover the cutout opening 311, 312 by overlapping with a portion of the first laminate structure 300 that completely surrounds and/or delimits the cutout opening 311, 312. The overlapping section 120 may be formed within this portion of the first laminate structure 300 and the bond between the two laminate structures 300, 400 may be formed along it. Preferably, the first laminate structure 300 and the second laminate structure 400 may be connected to each other directly, i.e. preferably without the provision of an additional adhesive layer that does not form part of any of the two laminate structures.

Preferably, the interface layer 420 and the compostable film material layer 320 may be connected to each other as exemplarily illustrated in FIGS. 3 and 8. Therein, it may be advantageous if the interface layer 420 may comprise or be made of the same material as the compostable film material layer 320 or of a polymer family member thereof. For example, the interface layer 420 may be made of PLA and the layer of the compostable film material layer 320 abutting the interface layer 420 also may be made of PLA. Therein, it may be advantageous and/or necessary to provide the interface layer 420 with an additional surface treatment and/or coating to provide the interface layer 420 with a gas/moisture barrier.

The second laminate structure 400 may be provided on the same side as the volume V with respect to the first laminate structure 300 as shown in FIGS. 1 to 3, for instance. Thus, the formable paper material layer 310 as well as the interface layer 420 may form the external side of the container wall 110. Preferably, it may be printed on the interface layer 420. The external side of the container wall no is the side that may come into contact with elements and/or surfaces of the beverage production machine. In comparison, the moisture barrier layer 321 and one of the group of the paper material layer 410, the filter layer 440 and the add-on layer 430 may form the internal side of the container wall 110. The internal side is the side, which may come into contact with the substance. Alternatively, the second laminate structure 400 may be provided on an opposite side as the volume V with respect to the first laminate structure 300 as exemplarily shown in FIGS. 7 and 8. Thus, the internal side of the container wall 110 may be formed by the formable paper material layer 310 as well as the interface layer 420. The external side of the container wall no may be formed by the add-on layer 430 and the moisture barrier layer 321. Preferably, it may be printed on the add-on layer 430 in such an exemplary configuration.

As described above, the container wall no may consist of two identical halves that may be sealed together. Preferably, the container wall no may comprise an identifier printed on a surface of the beverage container 100 directed away from the volume V. For example, the identifier may be printed on such a surface of the first laminate structure 300 and/or of the second laminate structure 400. The identifier may preferably comprise information relating to the type of the substance contained in the volume V and/or to beverage preparation parameters, such as defined pressure or temperature ranges required in the beverage preparation. For example, the beverage production machine may comprise a reading device for detecting and processing the identifier printed on the beverage container 100 to extract the information relevant for the beverage preparation process.

A further aspect of the present invention relates to a process for producing the above described compostable beverage container 100. Therein, the first laminate structure 300 and the second laminate structure 400 are provided. These steps are exemplarily illustrated in FIGS. 4A, 4C, 5A and 6A. At least one of the aforementioned cutout openings 311, 312 is cut into the first laminate structure 300. This is exemplarily illustrated in FIGS. 4B, 5B and 6C.

The first laminate structure 300 is formed such that the volume V is defined. As the volume of the beverage container 100 of the embodiments exemplarily illustrated in FIGS. 4 to 6 is formed by two separate elements 301, 302 of the first laminate structure 300, the step of forming the entire volume V is not illustrated in its entirety but would have to be repeated accordingly for the second of the two separate elements 301, 302. Thereby, the volume V may be formed in the forming step by circumferentially sealing the two separate elements 301, 302 of the first laminate structure 300 to each other along their respective circumferential edge section 303. This is only an example and various other ways to form the volume V are conceivable.

The first laminate structure 300 and the second laminate structure 400 are connected to each other, for example by gluing, heat sealing or by partial lamination, such that the second laminate structure 400 completely covers the at least one cutout opening 311, 312 to enclose the volume V. This is exemplarily shown in FIGS. 4C, 5C and 6B.

Preferably, the connecting step may be completed before the step of cutting the cutout opening 311, 312. This is exemplarily shown in the process illustrated in FIG. 6, where the two laminate structures 300, 400 are illustrated as being laminated onto each other (FIG. 6B) before the cutout opening 312 is cut into the first laminate structure 300 (FIG. 6C). Such a scenario may illustrate a case where it is conceivable, for example, that the interface layer 420 and the compostable film material layer 320 may be very different materials, i.e. they may not be or may not comprise a material of the same polymer family. In the processes illustrated in FIGS. 4 and 5, the connecting step may be completed after (FIGS. 4C and 5C) or at the same time as the step of cutting the cutout opening 311, 312 (FIGS. 4B and 5B).

Preferably, the connecting step may be completed before the forming step as exemplarily illustrated in FIGS. 5 and 6. Thereby, it may be possible to shape the beverage container 100 at the factory, in which the beverage container 100 is filled and sealed by the second laminate structure 400, for example. Alternatively, the connecting step may be completed after the forming step as exemplarily shown in the process illustrated in FIG. 4. Thereby, it may be possible to simplify the filling and closing process of the beverage container 100. Thus, the manufacturing and filling process can be varied in accordance with the application.

The forming step (FIG. 4A) may be completed before the cutting step (FIG. 4B) such as in the process illustrated in FIG. 4. Alternatively, the forming step (FIGS. 5D and 6D) may be completed after or at the same time as the cutting step (FIGS. 5B and 6C) such as in the processes illustrated in FIGS. 5 and 6.

The step of providing the first laminate structure 300 and/or second laminate structure may comprise a further step, which includes the step of cutting the respective laminate structure 300, 400 to size. This further step is exemplarily illustrated in FIGS. 5B and 6C and it may be carried out simultaneously with the step of cutting the at least one cutout opening 311, 312.

The invention is not limited by the embodiments as described hereinabove, as long as being covered by the appended claims. All the features of the embodiments described hereinabove can be combined in any possible way and be provided interchangeably.

1. Beverage container for preparing a beverage in a beverage production machine, wherein the beverage container is compostable and comprises a container wall that encloses a volume for containing a substance for the preparation of the beverage, wherein the container wall is made of a wall material that comprises at least two different laminate structures:
a first laminate structure, which is configured to be formable and defines the volume, wherein the first laminate structure comprises at least one cutout opening, and
a second laminate structure, which is configured to be openable upon interaction with opening elements of the beverage production machine under the effect of rising pressure of a fluid being injected into the beverage container, and
wherein the second laminate structure completely covers the at least one cutout opening so that the first laminate structure and the second laminate structure as the container wall completely enclose the volume-M.

2. Beverage container according to claim 1, wherein the first laminate structure comprises at least a formable paper material layer and a compostable film material layer as a moisture and/or an oxygen barrier, wherein the compostable film material layer is laminated or coextruded with the formable paper material layer, and the compostable film material layer comprises a compostable bioplastic.

3. Beverage container according to claim 1, wherein the second laminate structure comprises
a paper material layer, and
an interface layer.

4. Beverage container according to claim 3, wherein the second laminate structure further comprises
an add-on layer,
a filter layer, and
wherein preferably the add-on layer and/or the filter layer is provided opposite to the interface layer with respect to the paper material layer.

5. Beverage container according to claim 1, wherein the first laminate structure is configured such that it has an elongation at its breaking point of at least 2%, and
wherein the second laminate structure has a puncture resistance between 3 N/15 mm and 10 N/15 mm for an elongation between 1.5 mm and 3 mm.

6. Beverage container according to claim 1, wherein the second laminate structure is connected to the first laminate structure to completely cover the at least one cutout opening, and
wherein the second laminate structure is provided on an opposite or same side as the volume with respect to the first laminate structure.

7. Beverage container according to claim 1, wherein the first laminate structure consists of at least two separate elements that are circumferentially sealed to each other at a flange to enclose the volume, wherein the elements each comprise a circumferential edge section, which are arranged to overlap to form the flange.

8. Beverage container according to claim 1, wherein the first laminate structure comprises one or more further cutout openings that is/are completely covered by the second laminate structure to be opened by injection elements of the beverage production machine for injecting the fluid into the beverage container.

9. (canceled)

10. Beverage container according to claim 2, wherein the compostable film material layer comprises a layered structure, comprising:
a moisture barrier layer, the moisture barrier layer extends with a thickness in the range between 10 micrometers to 40 micrometers;
an adhesive layer made of an adhesive, the adhesive layer extends with a thickness in the range between 1 micrometers to 10 micrometers; and
a gas barrier layer, wherein the gas barrier layer extends with a thickness in the range between 1 micrometers to 20 micrometers; and
wherein preferably the compostable film material layer comprises a structure with the gas barrier layer being sandwiched between two moisture barrier layers forming the top and the bottom of the compostable film material layer, and with two adhesive layers, which are provided between each of the moisture barrier layers and the gas barrier layers, respectively.

11. Beverage container according to claim 1, wherein the container wall comprises an identifier, wherein the identifier comprises information relating to the type of the substance contained in the volume and/or to beverage preparation parameters.

12. Beverage container according to claim 1, wherein the beverage container is in a form selected from the group consisting of a pod, a capsule and a pouch.

13. Process for producing a compostable beverage container for preparing a beverage in a beverage production machine comprising the steps of
providing a first laminate structure, which is configured to be formable;
providing a second laminate structure, which is configured to be openable upon interaction with opening elements of the beverage production machine under the effect of rising pressure of a fluid being injected into the beverage container;
cutting at least one cutout opening into the first laminate structure;
forming at least the first laminate structure to define a volume of the beverage container for containing a substance for the preparation of the beverage; and
connecting the first laminate structure and the second laminate structure to each other such that the second laminate structure completely covers the at least one cutout opening to completely enclose the volume of the beverage container with the first laminate structure and the second laminate structure as a container wall.

14. Process according to claim 13, wherein the volume is formed in the forming step by circumferentially sealing at least two separate elements of the first laminate structure to each other along a circumferential edge section of the respective elements.

15. Process according to claim 13, wherein the first laminate structure and the second laminate structure are connected to each other, and
wherein the connecting step is completed before or after or at the same time as the step of cutting the cutout opening.
